(19) United States
(12) Patent Application Publication
(10) Pub. No.: US 2004/0030719 A1
(43) Pub. Date: Feb. 12, 2004

(54) Web page based dynamic book for document presentation and operation

(76) Inventor: Jie Wei, Singapore (SG)

Correspondence Address: Wei Jie, Blk 41, Bedok South Road, #13-725, Singapore, 460041, SG

(21) Appl. No.: 10/361,703

(22) Filed: Feb. 10, 2003

Related U.S. Application Data
(60) Provisional application No. 60/356,642, filed on Feb. 13, 2002.

(51) Int. Cl. G06F 17/00

(52) U.S. Cl. 707/104.1

(57) ABSTRACT

A method and system for dynamically generating a set of web pages named as Dynamic Book which are automatically linked with Visual Navigation Tabs or Dynamic Navigation Bars are disclosed. While navigating the said Dynamic Book, new pages, new sections and new books can be instantly generated and document objects can be instantly added to current page from local computer, computer network, computer peripheral devices and other information resources. Efficient presentation, categorization, indexing for document objects in web standard can be performed with this method and system. While navigating the said Dynamic Book and document contents, convenient document management, processing and communications can be carried out. In addition, Visual Hierarchical Cards, which integrate Dynamic Book with the hierarchical directory tree of computer operating system, are also disclosed.

### FIELD OF THE INVENTION

The present invention generally relates to web page and web browser based document presentation, categorization, indexing, management and communication on a computer or a digital processing system locally or over network, in particular to the dynamic generation of web pages with standardized and visualized navigation bars, and instant document operations on the web pages at navigation time.

### BACKGROUND OF THE INVENTION

HTML and Web Browser

HTML (HyperText Markup Language) is a markup language used for documents on the World Wide Web. HTML is an application of SGML that uses tags to mark elements, such as text and graphics, in a document to indicate how web browsers should display these elements to the user and should respond to user actions such as activation of a link by means of a key press or mouse click. HTML allows embedded “links” to point to other data or documents, which may be found on the local computer or other remote Internet host computers. When the user selects an HTML document link, the web browser can retrieve the document or data that the link refers to by using HTTP, FTP or other Internet application protocols. This feature enables the user to browse linked information by selecting links embedded in an HTML document.

The web browser is software that lets a user view HTML documents and access files and software related to those documents. Some examples of commercially available browsers, such as Microsoft's Internet Explorer, Netscape's Navigator, IBM's Web Explorer and Sun Microsystems's HotJava Browser are originally developed to allow users to view or “browse” documents on the World Wide Web. Web browsers can blur the distinction between local and remote resources for the user by also providing access to documents on a network, an Intranet, or the local hard drive. Web browser software is built on the concept of hyperlinks, which allow users to point and click with a mouse in order to link to documents in whatever order they desire. Most Web browsers are also capable of downloading and transferring files, providing access to newsgroups, displaying graphics embedded in the document, playing audio and video files associated with the document, and executing small programs, such as Java applets or ActiveX controls included by programmers in the documents. Third party applications, helper applications or plug-ins are required by some web browsers to accomplish one or more of these tasks.

Web Site Hierarchy and Navigation Bars

In web site design and construction, a navigation bar with hyperlinks linking to local main sections is commonly used to provide a visual and logical site hierarchy in a consistent style. The relationship of a web page to its sister, child and ancestor pages can be indicated. Usually, a navigation bar is a group of graphics or images or an image map with hyperlinks. They are created manually or half manually by means of web authoring tools. The titles on the graphics or images are also graphic or image format, so that they cannot be generated and changed dynamically from a user interface at navigation time, with support of software program and/or database. Another type of navigation bar in text titles and text-based hyperlinks can be dynamically generated but there is no stylish look-and-feel comparing to a graphic or image navigation bar.

To consistently organize the web contents and display them on a multi-page web site, a template with navigation bar can be created first, then filled with contents, saved in different filenames and linked together by hyperlinks. In such a way, web contents are presented in a multi-page web site.

Hierarchical Document (File) Management System

An operating system always has built-in hierarchical document (file) directories in a so-called tree structure. Commercially available products implement additional features that provide more sophisticated means of navigating, finding, and organizing files. MS Windows Explorer enables the user to locate and open files and folders. The user can select folders from a list displayed on the left side of the screen and access files in a selected folder from a list displayed on the right side of the screen. Compared to the directory tree system using character interface such as MS DOS, window based folder system has significantly improved with look-and-feel of folders and ease-of-use in drag-and-drop. It is designed to incorporate to application programs and is optimized to manage files by displaying the title and attributes of files. Comparing to web page presentation, it looks more like a directory book rather than a content book. Although the latest Windows Explorer implements displaying in web style, it is still far from an ideal user-friendly interface to directly support contents displaying in rich styles as a web page.

Integration of Web Browser and Operation System

There is an increasing demand for applications that can access the Internet and take advantage of Internet related standards. When using web browser to surf the Internet, significant ease-of-use is based on the powerful hyperlinks, which bring surfers from pages to pages around the world. However, such an advantage has not yet been applied to the computer file management system to make users view the document in the similar way for surfing the Internet. Web page based user interfaces, which integrate document management and content presentation, are not yet fully developed.

As the common platform for displaying web standard documents, web browser provides more support to general document formats with built-in modules or plug-ins. With the popularity of XML and enhancement of hardware, web standard is playing a leading role so the web browser should be a versatile user interface for both local computer operating system and web communications.

With the development of e-business, as well as the improvement of displaying resolution of computer screen, handling plenty of electronic documents is becoming a daily office job including document viewing, management, storage, navigation, indexing, and transferring. More efficient and user-friendly interface and document centric operating environment like so-called paperless office and mobile office are in demand. Taking advantage of the hyperlink function and document visualization in web presentation and applying them to document management and operating system, Web standard based document presentation, storage, management and communication may eventually replace the conventional approach which was optimized for stand-alone computers and application programs.

### BRIEF SUMMARY OF THE INVENTION

A method and system for dynamically generating a set of web pages named as Dynamic Book which are automatically and uniformly linked with Visual Navigation Tabs or Dynamic Navigation Bars are disclosed. While navigating Dynamic Books, new pages, new sections and new books can be instantly generated and document objects can be instantly added to current page from local computer, computer network, computer peripheral devices and other information resources. Efficient presentation, categorization, indexing for document objects in web standard can be performed with this method and system. While navigating the contents of documents, convenient document management, processing and communications can be carried out. In addition, Visual Hierarchical Cards, which integrates Dynamic Books with the hierarchical directory tree of computer operating system, are also disclosed.

As we known, the existing window folder system has advantages of easy operation and clearly displaying the hierarchical structure of folders and files, but one of its shortcomings is that only titles and attributes are displayed in a narrow space without rich styles and direct support to link and display contents. Web pages, on the other hand, provides a more friendly environment and powerful navigation function with hyperlinks, but the generation of web page is not as straightforward as adding a new folder and putting documents inside. The sense of loss during surfing plenty of web pages always overwhelms the surfers. To make full use of the advantages and to overcome the shortcomings of the two systems mentioned, this Dynamic Book system is invented and the advantages of it are summarized as the following:

Dynamic and instant generation of a Dynamic Book (a set of web pages) at navigation time on a web browser interface can be done with a simple mouse click. Based on this Dynamic Book, a view-and-do environment is created. Ease-of-use and efficiency of document filing and operations including document management, storage, presentation, categorization, indexing and communications are significantly improved in this new environment.

In this environment, physical files and books are modeled for document filing and operations. In the file or book, navigation bars in the form of index dividers with tabs or labels display the hierarchical structures of the book in a consistent style. It makes surfers view document objects more like reading a real book and performing filing works in a conventional manner of physical filing.

In addition, the Dynamic Book is in the web page format and the filing work produces the same results as web site construction. Dynamic Books and the hosted documents can be viewed in standard commercial web browsers anywhere.

### BRIEF SUMMARY OF THE DRAWINGS

FIG. 1 illustrates by way of example a currently displayed Dynamic Book comprising Visual Navigation Tabs and displayed document objects, and a Dynamic Bookshelf.

FIG. 2 shows an application program user interface for Dynamic Books comprising menus, toolbars, web browsers (or web viewer) window and Working Desk.

FIG. 3 illustrates by way of example a typical two-level Visual Navigation Tabs comprising upper level tabs, current upper level tab, lower lever tabs and current lower level tab.

FIG. 4 illustrates a typical Visual Navigation Tab comprising left border image, middle image as the background, a title in text format and right border image.

FIG. 4A shows how typical Visual Navigation Tabs as indicated in FIG. 4 are written in HTML.

FIG. 5 illustrates by way of example typical Visual Navigation Tabs in three hierarchical levels.

FIG. 6 illustrates by way of example a typical Visual Navigation Tab in form of an attached label.

FIG. 7 illustrates by way of example typical Visual Navigation Tabs with images or small icons.

FIG. 8 shows alternative Visual Navigation Tabs at the bottom of a Dynamic Book.

FIG. 9 shows alternative Visual Navigation Tabs set vertically to the left edge of a Dynamic Book.

FIG. 10 shows alternative Visual Navigation Tabs set vertically to the right edge of Dynamic Book.

FIG. 11 shows alternative Visual Navigation Tabs set vertically to the left edge of Dynamic Book, but the titles are written horizontally.

FIG. 12 shows alternative Visual Navigation Tabs set vertically to the right edge of a web page, but the titles are written horizontally.

FIG. 13 is a flowchart showing, in one preferred embodiment, how to customize a Dynamic Book and how to operate hosted document objects or web contents from a user interface at navigation time in local computer.

FIG. 14 is a flowchart showing, in one preferred embodiment, how to customize a Dynamic Book and how to operate the hosted document objects or web contents from a user interface at navigation time over client-server network.

FIG. 15 is an overview of Navigation Time Operations Icons for instant document communications, customization etc.

FIG. 16 shows Navigation Time Operations Icons for instant generation of new Dynamic Books, new Sections and new Dynamic Pages, as well as changing titles, orders of a Dynamic Book, Section and Dynamic Page at navigation time.

FIG. 17 shows Navigation Time Operations Icons for instant input of document objects to current page from different sources such as digital camera, scanner, PDA (Personal Digital Assistant), local computer, email, fax and computer networks etc, as well as instant output via email, fax, local computer networks or other Internet application protocols etc.

FIG. 18 illustrates by way of example how a Book Cover is dynamically assembled with left border image, middle background image, title in text format and right border image.

FIG. 18A illustrates how a Dynamic Bookshelf with Book Covers is written in HTML.

FIG. 19 illustrates by way of example how Dynamic Bookshelves with Book Covers are arranged in two rows.

FIG. 20 illustrates by way of example how a full size Book Cover for Dynamic Book is dynamically assembled with image elements and the title.

FIG. 21 shows the environment of Dynamic Library with Bookshelves and Dynamic Books.

FIG. 22 illustrates by way of example different types of computer documents objects displayed such as web page in HTML and XML, images, web links and local links, emails and other popular documents, as well as music, video documents and so forth.

FIG. 23 illustrates by way of example how web compatible images or graphics are directly displayed.

FIG. 24 illustrates by way of example how web page in html is directly displayed on a Dynamic Page.

FIG. 24A illustrates by way of example how text format objects are displayed as business cards, reminders and contact slips etc with links to URLs, email addresses, telephone numbers, fax numbers and local document object.

FIG. 25 illustrates by way of example how Quick View displays a document object in a frame by clicking on Local Index in the thumbnail.

FIG. 25A illustrates by way of example how Quick View displays a document object in a frame by clicking Local Index in the filename.

FIG. 26 illustrates Working Desk with tool bar and an additional web viewer for making efficient document operations.

FIG. 27 shows details of tool bar on Working Desk.

FIG. 28 shows that Visual Navigation Tabs are separated as two volumes.

FIG. 29 shows that Visual Navigation Tabs are separated as two rows.

FIG. 30 illustrates by way of example a Table of Contents based on the existing structure of the Dynamic Book.

FIG. 31 illustrates by way of example Bookmarks linking to marked pages and Shortcuts linking to marked document objects.

FIG. 32 is an alternative embodiment, which indicates how Dynamic Navigation Bars consistently display the hierarchical structure and logical relation between the current page and the rest of the pages in the book.

FIG. 33 is an alternative embodiment, which indicates how a Dynamic Navigation Bar highlights the location of the current Section or the current Page.

FIG. 34 is an alternative embodiment, which indicates how a Dynamic Navigation Bar in another style highlights the location of the current Section or the current Page.

FIG. 35 illustrates by way of example a typical currently displayed Visual Hierarchical Card where an image object is directly displayed in a frame and sub cards under this card are listed.

FIG. 35A shows a currently displayed Visual Hierarchical Card where the document objects under this card are listed and one of listed document objects is currently displayed. This card is a sub card in FIG. 35.

FIG. 36 shows hierarchical directory tree in Window Explorer, which corresponds to a set of Visual Hierarchical Cards in FIG. 35A.

### DETAILED DESCRIPTION OF THE INVENTION

Dynamic Book

A method and system of making web pages on a local computer, computer over the network, a digital device or a digital processing system are disclosed.

The said web pages are dynamically generated and revised with the support of software programs being executed on a local computer or computers over the network or a digital processing system or a digital device.

Preferably, on the user's machine, the said supporting software programs may be built-in modules in an implemented web browser, a stand-alone application including web browsers, hypertext viewers, plug-ins incorporated with standard web browser, applets, other approaches with communication to web browser or their combinations.

The said supporting software programs may be server side applications with the communication and construction mechanisms like CGI (Common Gateway Interface) and ASP (Application Server Pages) etc, communicating with Hypertext Markup Language (HTML) web browser user interface via Hypertext Transfer Protocol (HTTP) or other Internet application protocols.

In preferred embodiment, the present invention is applied on local computer or computers over the network. It can be applied on other digital processing system or digital devices include but are not limited to digital camera and its accessories, digital video camera, PDA (Personal Digital Assistant), digital copier, fax machine and their combinations, e-book viewer, web TV and so forth.

Preferably, the web pages may be written in Hypertext Markup Language (HTML). They can be written in the sister and successor languages of HTML such as XML, XHTML and other markup language, but they are not limited to the mentioned languages.

The said web pages dynamically generated are a set of structured pages and named as Dynamic Book. The structure of the Dynamic Book corresponds to a set of structured data in the form of database, data file, XML file, directory tree of file system or their combinations. The said structural data may be the existing ones or being generated from a user interface at navigation time. The page of a Dynamic Book can be generated in batch or one by one, and the changes or revision can be made at navigation time with the support of structural data and software programs.

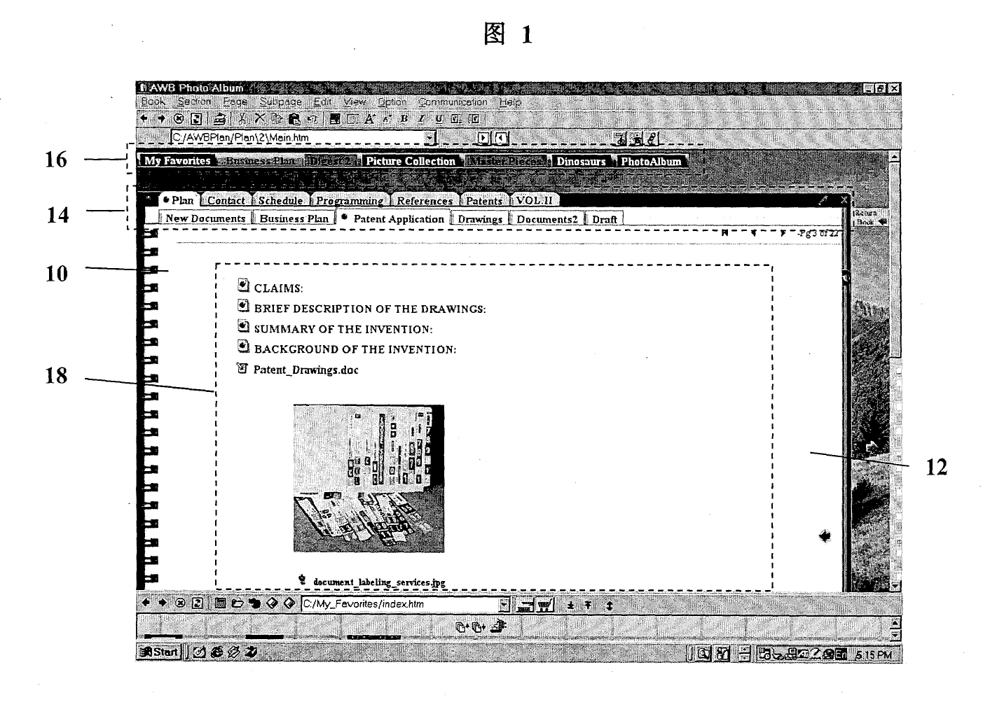

In preferred embodiments, a web page for displaying Dynamic Books is written in Hypertext Markup Language (HTML) is displayed on a web browser or a web viewer interface as shown in FIG. 1. Dynamic Book 10 here is virtually presented with the look-and-feel of a real book or a real file with index dividers with tabs or labels. The said Dynamic Book is not limited to this kind of style and appearance and it has more varieties in other embodiments that will be described later on. The said Dynamic Book is featured in its dynamical generation and revision of web pages and instant document operation on a web page as a user interface, supported by the software programs and the structured data. It is also featured in Visual Navigation Tabs 14 or Dynamic Navigation Bars, which are dynamically generated and display the hierarchical structure of web pages and provide hyperlinks to the Sections, Sub-Sections and pages of the Dynamic Book. The said document objects 18 in this description include all types of computer files such as text documents, data files, graphic files and multi-media files etc.

In preferred embodiments, Dynamic Book 10 is visually divided into Dynamic Pages by means of Dynamic Navigation Bars 14. Dynamic Page 12 in Dynamic Book 10 is for displaying the document objects 18 or displaying web page contents directly. Optionally, at top of the web page, a set of navigation bars named as Dynamic Bookshelf 16 can be added, which provides links to other Dynamic Books.

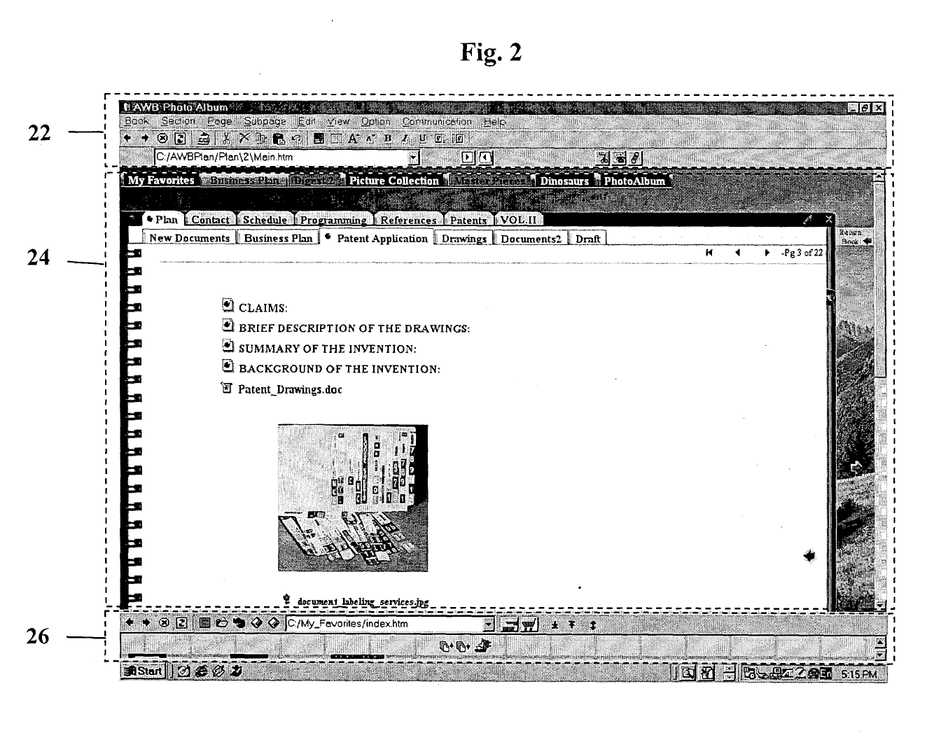

In preferred embodiments, as shown in FIG. 2, the said Dynamic Book is driven by software programs with user interface including web browser (or web viewer) 24, toolbars and menu 22 in the same way as those of a Windows application. Alternatively, Navigation Time Function Icons on the web page with support by built-in modules or plug-ins or Java applets etc for user's machine will be described in the later part of the description.

Dynamic Navigation Bars

In the said Dynamic Book, the pages are organized in a hierarchical structure like chapters, sections of a book, or a dividers and sub dividers of a physical file, or a simple case in linear structure like page by page. The Dynamic Navigation Bars consistently display the hierarchical structure partially or fully, and indicate the logical relation between the current page and the rest of the pages of the book. Hyperlinks to the rest of the pages of the book are provided to let users link to the rest of the pages in the book.

The top hierarchical level is represented in Sections when the hierarchy is in more than one level, and the lower hierarchical levels are represented in sub-Sections when the hierarchy is in more than two levels.

Preferably, the Dynamic Navigation Bars are dynamically generated with the generation of the Dynamic Book. There are many varieties in the style of the Dynamic Book and the dynamic Navigation Bars, which will be described at a later part of the description.

Visual Navigation Tabs

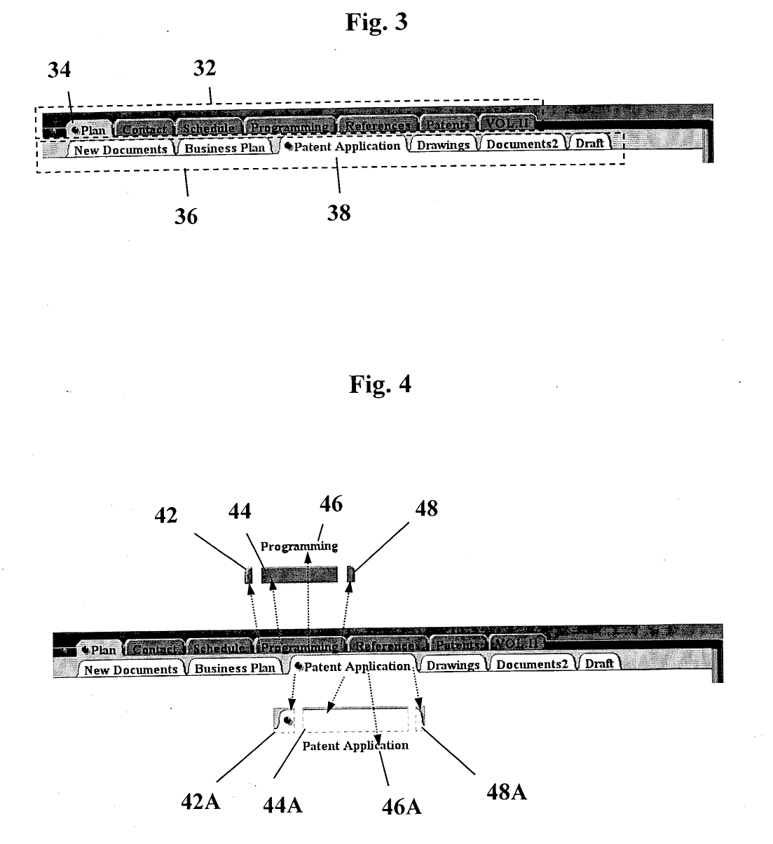

In preferred embodiment, based on the hierarchical structure of the Dynamic Book, a set of standardized navigation bars named as Visual Navigation Tabs are dynamically generated on each web page. The said Visual Navigation Tabs are featured in visual effects of physical index dividers with tabs or labels of real books or real files, and visual effects of current index dividers, tabs or labels are visually brought to the front. These visual effects provide look-and-feel and clearly indicate the current locations of the Section and Page. FIG. 3 shows typical two-level Visual Navigation Tabs. The upper level tabs 32, current upper level tab 34, lower lever tabs 36 and lower current tab 38 are indicated.

The said Visual Navigation Tabs are dynamically assembled with graphics (or images) and text. These graphic and text elements are matched together by cells and tables in syntax of markup language, and hypertext links on the Visual Navigation Tabs are written to link the rest of the Dynamic Pages or the rest of the Sections (or Sub Sections) of the Dynamic Book.

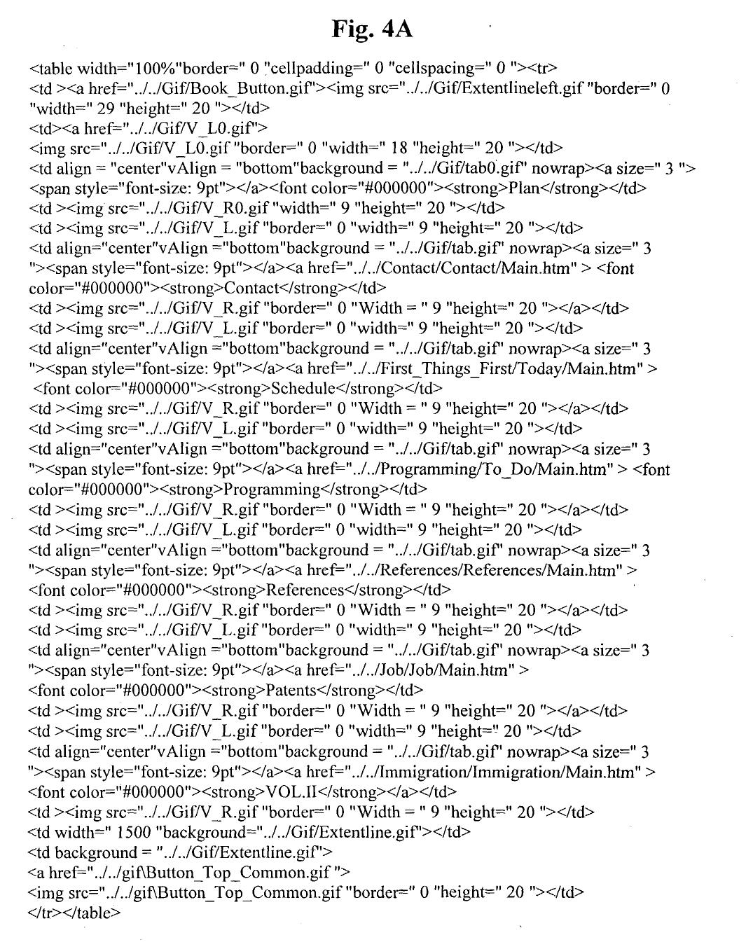

Preferably, as shown in FIG. 4, one Visual Navigation Tab consists of three basic elements in three cells of a stable. The left cell has an image-left tab border 42 and middle cell has an image-middle tab 44 as the background, and a title for identifying information in text format 46. The width of the background image and cell can be automatically adjusted with the length of title. The right cell has an image-right tab border 48. The titles 46 and 46A are in text format which can be changed by dynamically rewriting the titles from program user interface or based on database, instead of the graphic format which needs to be edited with graphic editing tools.

Preferably, a lower Visual Navigation Tab is assembled in the same way, which basically consists of left tab border 42A, middle tab 44A as the background, a title in text format 46A and right tab border 48A. As a typical example, the upper Visual Navigation Tab indicated here is a non-current tab and the lower Visual Navigation Tab is a current tab.

When the web pages are dynamically generated in group or one by one, the grouped pages are automatically linked with each other using hyperlinks on the Visual Navigation Tabs. The dynamically generated titles (on the Visual Navigation Tabs) for the Dynamic Pages, the Sections or the Sub Sections of the Dynamic Book are in text format, which can be dynamically written and dynamically changed. In the Dynamic Book, preferably, the highlighted current tab (for the currently displayed Dynamic Page) shows a visual effect that the Dynamic Page is brought to the front virtually. The highlighted current tab (for Section) shows a visual effect that the current Section (or group of pages) is brought to the front visually.

FIG. 4A illustrates how the upper Visual Navigation Tabs is written in HTML in one preferred embodiment.

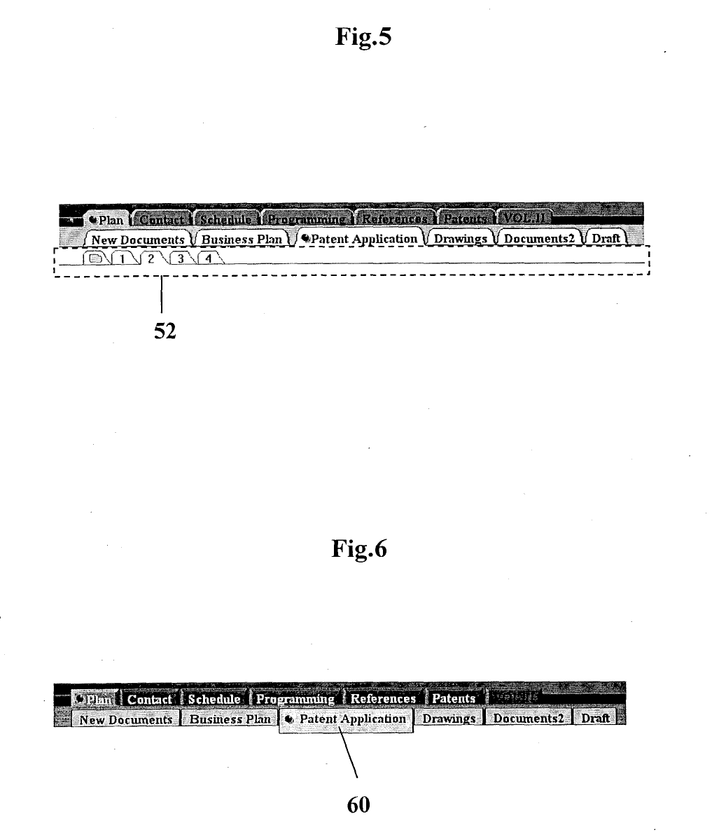

Preferably, the Visual Navigation Tabs may be in two levels as shown in FIG. 2 which includes Section Tabs 32, and Page Tabs 38. Typically, the Visual Navigation Tabs can be only in one level with the simple linear structure. A three-level Visual Navigation Tabs which includes Section Tabs, sub-Section Tabs and Page Tabs 52, are shown in FIG. 5. Generally, the hierarchical structure can be in multiple levels unlimited. At any level, the hosted document objects can be displayed in file name, title, thumbnail, meta-data, contents partially or fully.

The varied styles of Visual Navigation Tabs which still features in highlighting of the location of current Section (sub-Section) and Dynamic Page, and the method for assembling the Visual Navigation Tabs as described before are still within the definition of Visual Navigation Tabs and within the scope of invention. For example, a tab can be in an alternative form like an attached label 60 as shown in FIG. 6, which is still a Visual Navigation Tab that performs the same function but in a different style.

The additional highlighting effect can be added to the current tabs in different colors, shapes, marks, lighting and animation effects and so forth. Alternative highlighting effect can be applied in different colors, shapes, marks, lighting and animation effects and so forth. With these effects, the styles of Visual Navigation Tabs can be diversified but they are still within the definition of Visual Navigation Tabs and within the scope of the invention.

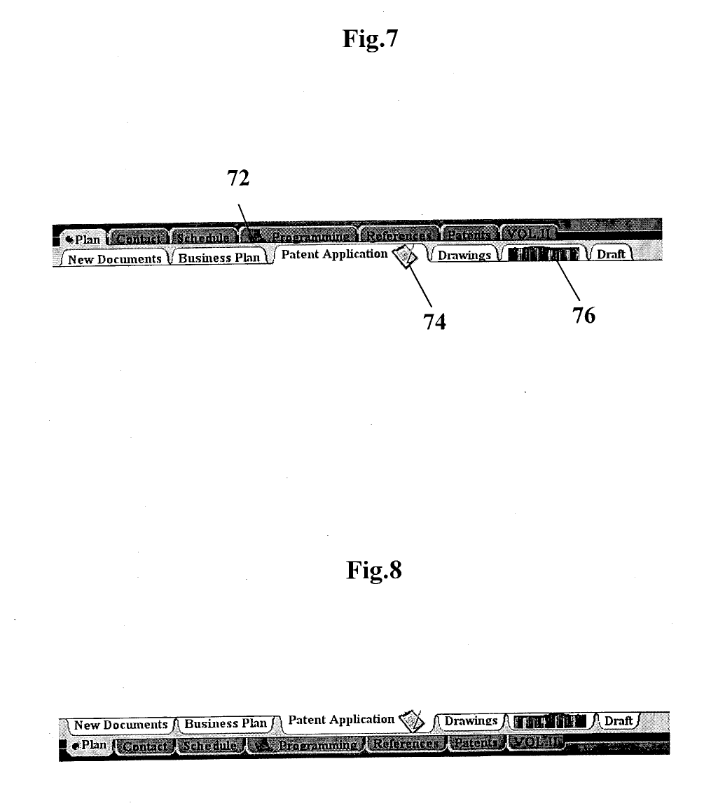

As shown in FIG. 7, an image or small icon 72 can be added and matched to the left tab borders image 42, and an image or small icon 74 can be added and matched to the right border image 48A. An image can be also added and matched to the middle of the background image 44A. In a particular case, image 76 can be added to fully replace text title.

Preferably, the Visual Navigation Tabs are set to top edge of the book as illustrated in FIG. 1. Alternatively, the Visual Navigation Tabs can be set to bottom edge of the book as illustrated in FIG. 8.

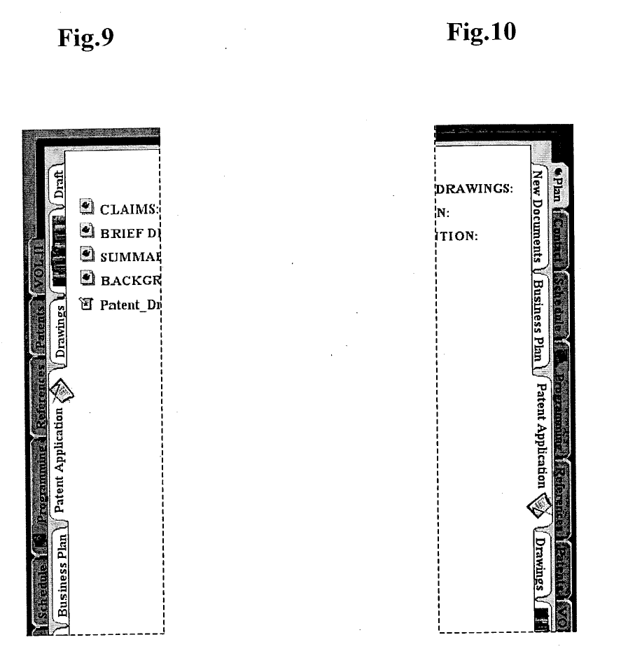

Alternatively, the Visual Navigation Tabs can be set to the left edge of the book vertically as shown in FIG. 9, or to the right edge of the book vertically as shown in FIG. 10.

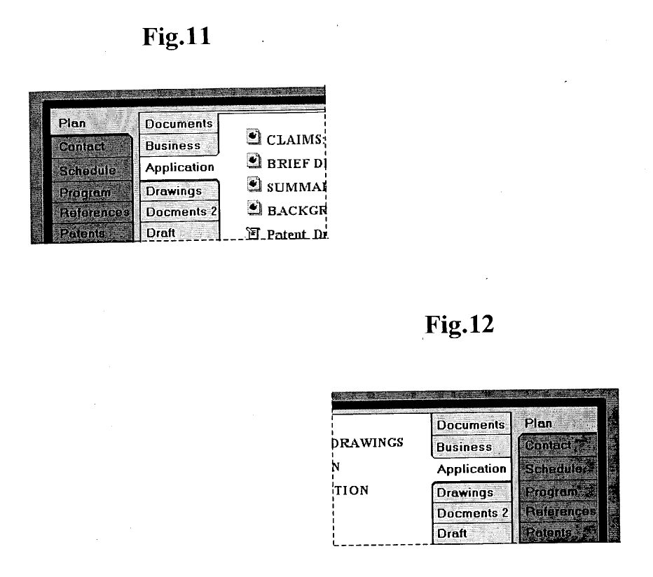

Alternatively, VisualNavigation Tabs can be set to the left side of the book vertically, as shown in FIG. 11, or right side of the book vertically, as shown in FIG. 12. The tabs are arranged vertically but the titles are written horizontally and the visual effect of highlighting the current location is remained.

Navigation Time Operations

The generation of Dynamic Book can be based on pre-prepared data or system directory structures (hierarchical tree) to describe the structure of Dynamic Books. For example, when a user inquire information on keywords, the local application or server side application responds by searching the database and present the results. Instead of generating pages in linear structure to list all the related titles of information, structured web pages (Dynamic Books) can organize and present the required information in hierarchical structure and provide a user friendly interface for easy surfing. The Dynamic Book here is generated in batch based on the keywords and related databases which include the information itself and structure of the information.

Preferably, another way is that one Dynamic Book including at least one page is generated at first. Based on this page, the Dynamic Book can be expanded and customized, and the hosted document objects or web contents can be operated from a user interface at navigation time.

Preferably, the expansion and customization like adding Sections, Sub Sections, Pages etc can be done in response to the request by users, and the change of the Dynamic Book is immediately updated and displayed on the web browser or web viewer. The operations for the hosted document objects or web contents include inputting, copying, moving, deleting and outputting (via email, FTP or Fax etc). These operations are named as Navigation Time Operations here which is different from the methods like normal web site construction and other existing server side dynamic web page construction. Such interactions can be done not only in the local computer but also in the network computers via the network based on the web browser interface.

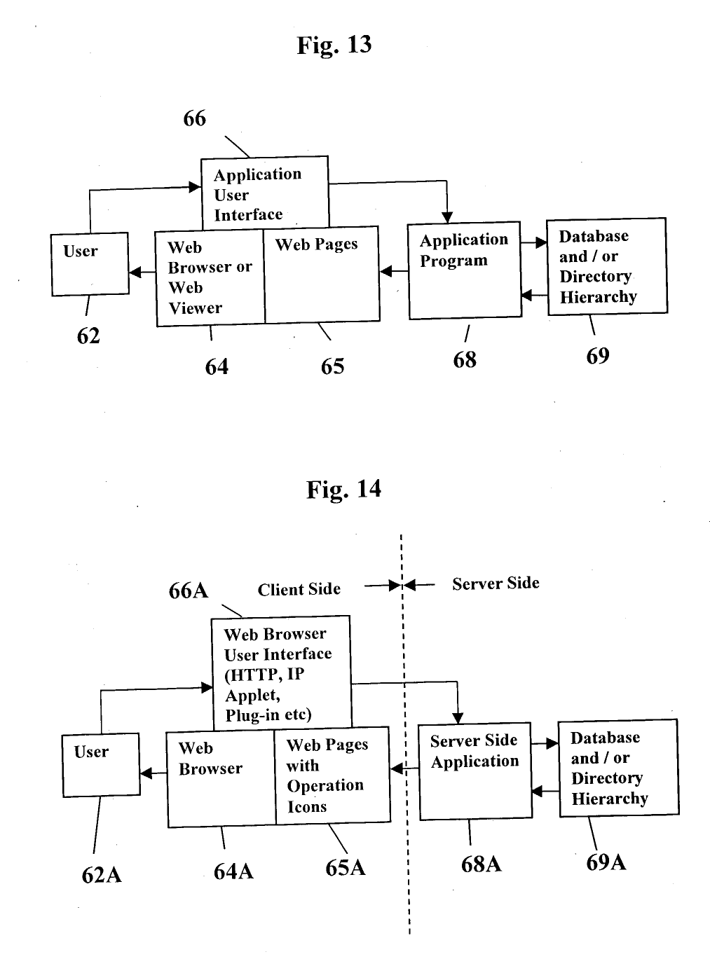

When the method and system is served on the user's machine only, the software programs can be built-in module in an implemented web browser or a stand-alone application including hypertext web viewer. Refer to FIG. 13, where user 62 navigates the web pages 65 on a web browser or a web viewer 64, a request can be sent via application interface 66 to the application program 68. The program processes the request and updates the database 69 and/or directory hierarchy 69 of the system. Based on the updated database 69 and/or directory hierarchy 69, the program 68 updates (generates and revises) the web pages 65 and present the web pages on the web browser or web viewer 64 to user 62.

When this method and system is applied to client/server architecture over network, FIG. 14 gives a typical flowchart to illustrate how to expand and customize the Dynamic Book and operate hosted document objects or web contents from a user interface at navigation time. When network user 62A navigates the web pages 65A which have operation icons on a web browser 64A, a request can be sent via user interface 66A which includes internet mechanism HTTP, IP, Applet, ActiveX and plug-in etc. The request has been sent to the server's application program 68A. The program 68A processes the request and updates the database 69A and/or directory hierarchy 69A of the system. Based on the updated database 69A and/or directory hierarchy 69A, the program 68A update (generate and revise) the web pages 65A and present the web pages on the web browser 64A to user 62A. Although the method in FIG. 14 is typical for client/server architecture over network, the method is applicable for wide area network, local area network and local computer system.

Adding Dynamic Pages

With the Navigation Time Operations, a new Dynamic Page 12 (or a lower lever tab 36) can be instantly added to the Dynamic Book in response to a request from the user interface while the user navigates the Dynamic Book. A Visual Navigation Tab representing the newly added Dynamic Page is also automatically generated and incorporated into the existing Visual Navigation Tabs. The Visual Navigation Tabs on the rest of the existing web pages of the Dynamic Book linking to the newly added Dynamic Page are automatically rewritten and updated.

Similarly, a new Section (upper level tab) 32 can be added to the Dynamic Book in response to a request from the user interface at navigation time. A Visual Navigation Tab representing the newly added Section is also automatically generated and incorporated into the existing Visual Navigation Tabs. The Visual Navigation Tabs on the rest of the existing web pages of the Dynamic Book linking to the new added Section or sub-Section are automatically re-written and updated.

Customizing Titles of Pages, Sections and Books

With the said Navigation Time Operations, the titles 46 and 46A on navigation tabs 32 and 36 can be instantly changed in response to a request from the user interface while the user navigates the Dynamic Book. The titles on the rest of the web pages of the Dynamic Book are automatically re-written and updated.

Customizing the Order of Pages, Sections and Books

The orders of Dynamic Page, Section Tabs, Sub Section Tabs and Page Tabs which are arranged from left to right or top to bottom can be rearranged in response to a request from user interface at navigation time by changing the order of controlling data embedded. The changes can be controlled in one step or more than one step in the intended direction.

Adding a New Dynamic Book

Above the currently opened Dynamic Book 10, Book Covers (in partial book cover) displayed in a row as Dynamic Bookshelf 16. A Book Cover represents an existing Dynamic Book and has a link to the book. At navigation time, a new Dynamic Book represented with a new Book Cover can be added in response to a request from user interface.

Dynamic Bookshelf

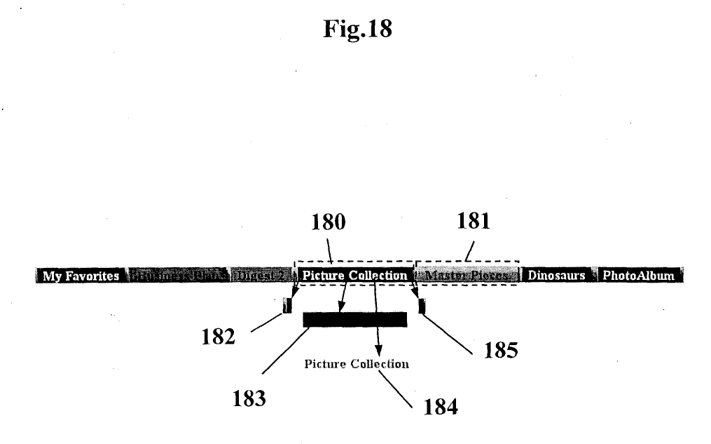

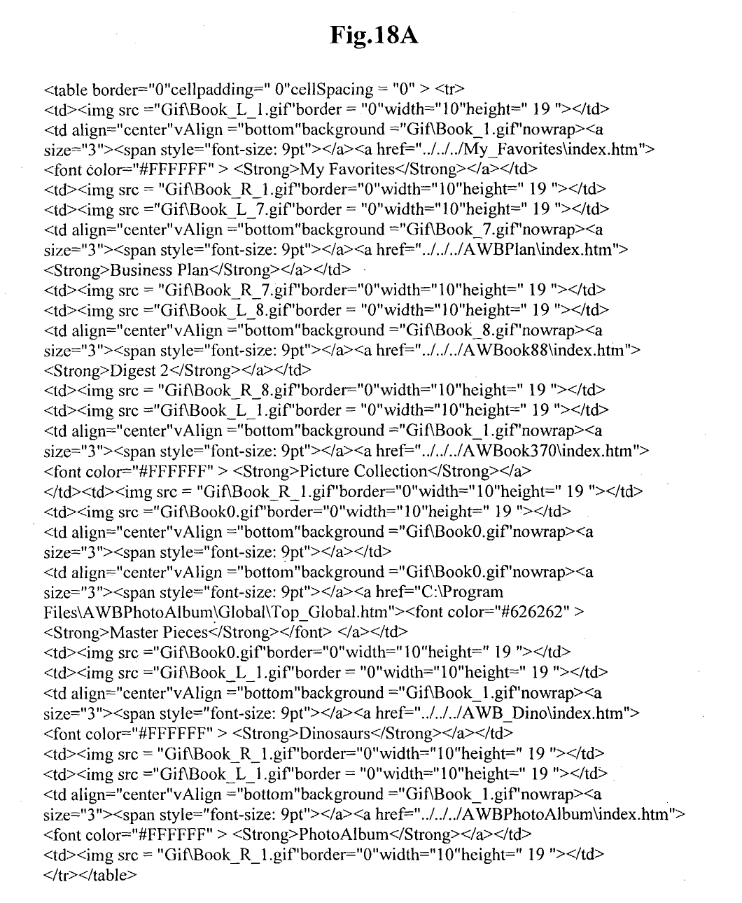

In preferred embodiments, as shown in FIG. 18, the said Book Cover is dynamically assembled with graphics (and/or images) and titles in text format, which match-together in cells of a table in the syntax of markup language. Preferably, Book Cover 180 basically consists of left border image 182, middle background image 183 and title 184 in text format and right border image 185. A currently opened Dynamic Book is represented by a special Book Cover 181, which is made in a similar mechanism as the typical Book Cover 180, but has a special effect. The special effect presents the current book is brought down visually. This special effect could be a special mark or a highlighting effect.

FIG. 18A indicates how the Dynamic Bookshelf and Book Covers as the navigation bars are written in HTML in preferred embodiment.

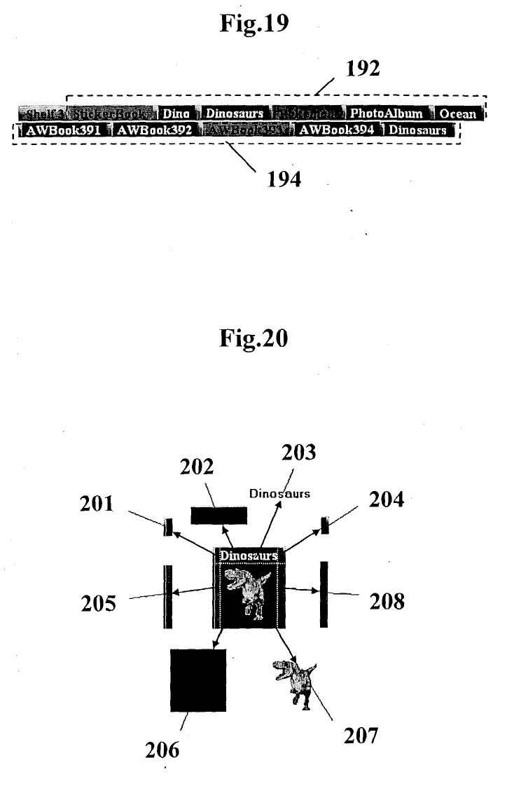

The Dynamic Bookshelf and Book Covers can be arranged in two rows as shown in FIG. 19, where the upper Dynamic Bookshelf 192 is matched with the lower Dynamic Bookshelf 194 with the support of the table in markup language. In the same way, the Dynamic Bookshelves can be extended to more than two rows.

Alternatively, a Book Cover can consist of additional images or icons, or fully replaced with an image in the system.

Alternatively, a Book Cover can also be full sized as shown in FIG. 20 with the support of the table in markup language. It has basic elements matched together which consists of top-left border image 201, top middle background image 202, title in text format 203, top-right border image 204, lower-left border image 205, lower-middle background image 206, cover image 207 and lower-right border image 208. Alternatively, this full sized cover can be replaced with an image in the system.

Dynamic Library

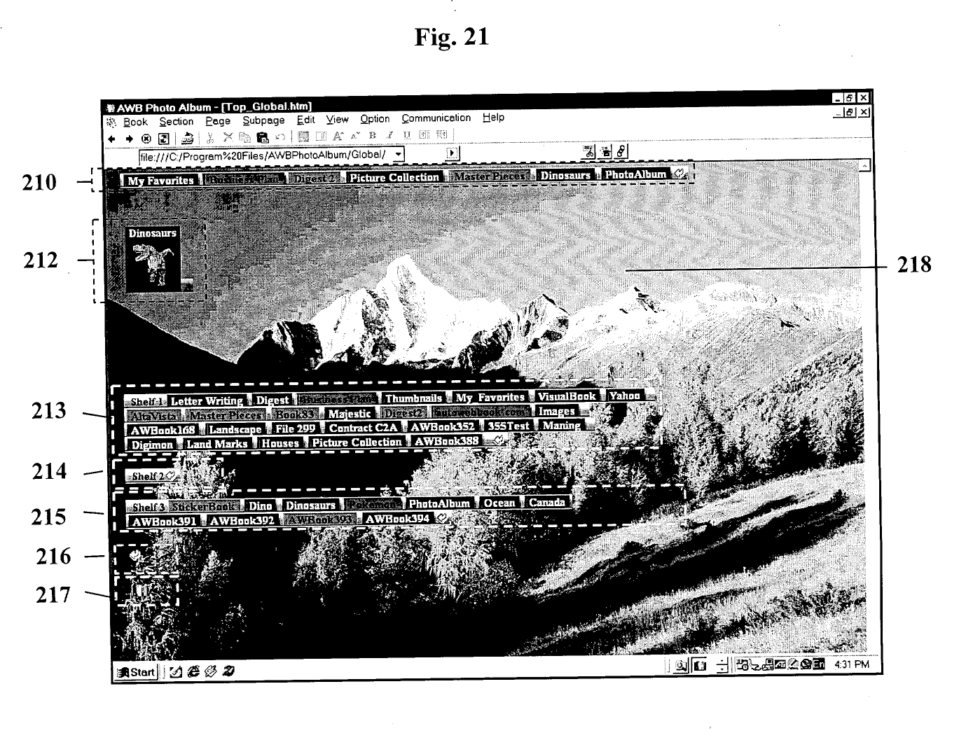

With the increment of Dynamic Books and Dynamic Bookshelves in the system, a linked web page named as Dynamic Library is presented as shown in FIG. 21. In the Dynamic Library, there is the top Bookshelf 210 which can be the same as 16 in FIG. 1, Bookshelf 213, Bookshelf 214 (where the Dynamic Books are hidden) and Bookshelf 215. Besides, link 216 is used for generating a new Bookshelf and link 217 is for generating and linking to a new Dynamic Library. Background 218 provides a visual environment for the Dynamic Library.

In the Dynamic Library, Dynamic Books can also be presented in a full sized book cover 212, which is indicated in FIG. 20.

Adding Document Objects

The currently displayed page in a Dynamic Book defines a local directory path or an URL, which can be used for instant document management and operation. With this defined directory path or an URL, instantly adding document objects to the currently displayed Dynamic Page in response to a request from a user interface at navigation time can be produced. Directly inputting document objects from digital camera, scanner, digital copier, PDA, local computer folder, computer network and Internet etc can be conducted by executing program modules in the system or third party applications.

Accompanying a new document object is added to the currently displayed Dynamic Page in response to a request from a user interface at navigation time, a corresponding application program can be activated for immediate editing or processing the newly added document object. Alternatively, the newly added document object can be dragged and dropped to an application program object and can be immediately edited and processed.

Displaying Document Objects

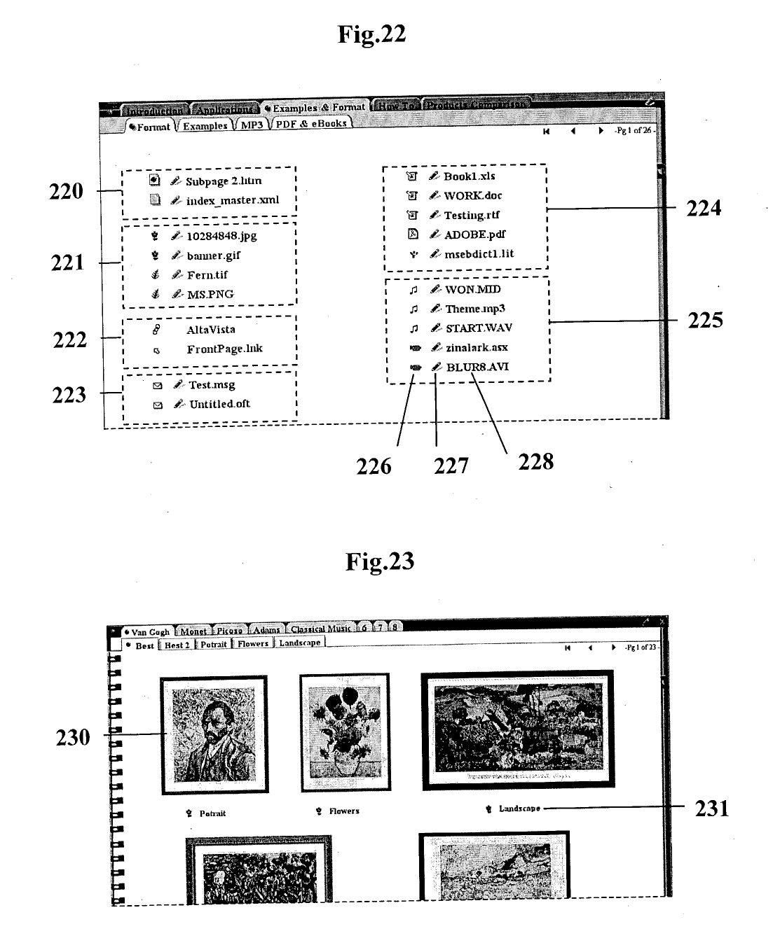

In preferred embodiments, as shown in FIG. 22, all type of computer documents objects such as web page in HTML and XML 220, images 221, web links and local links 222, email messages 223, popular documents 224, music and video documents 225 and so forth.

A document object can be displayed typically in filename 228, which links to the document object itself. In addition, a metafile for the document object can be created in text or XML format including the information about the document object such as attribute, key words, titles and abstracts etc. Icon 226 links to the meta-data file of the document object. Icon 227 is a link to a default application for editing or executing the corresponding document object.

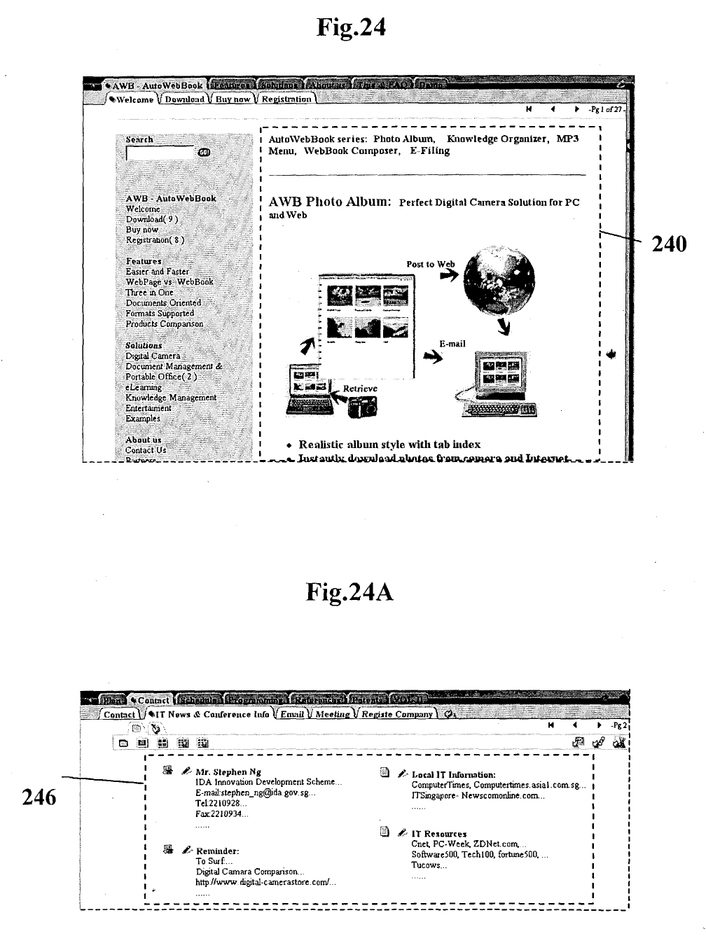

If the displayed document objects are images or graphics in the web compatible formats, as shown in FIG. 23, they can be directly displayed as 230 and can be customized in the intended size and layout in response to a request from a user interface. The title or metadata can also be directly displayed as 231. If the displayed document objects are web objects like web pages in HTML or its successors or other document objects in web compatible formats, they can be directly displayed on the Dynamic Page. A static web page content 240 in FIG. 24 is directly displayed.

In addition, text format objects 246 such as business cards, reminders, contact and information slips etc with links to URLs, email addresses, telephone numbers, fax numbers, local document objects etc can be partially or entirely displayed.

Quick-Viewing with Support of Frames

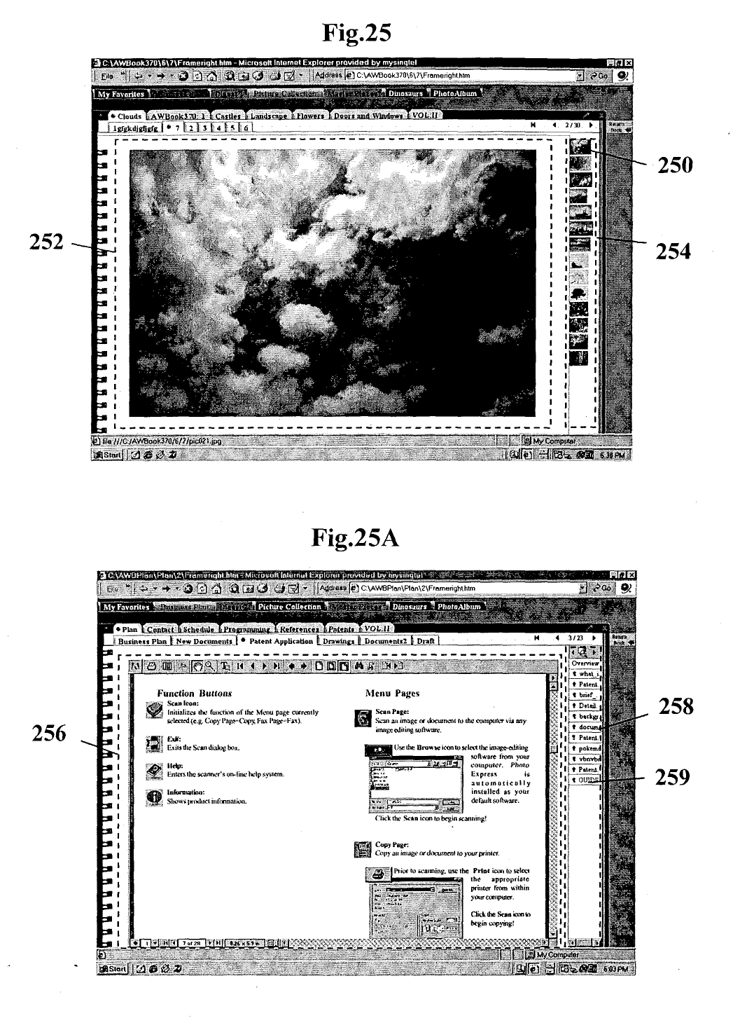

Referring to the list of document objects 220, 221, 222, 223, 224 and 225 in FIG. 22, the document objects can be navigated by opening one by one jumping between the book and the document objects. To quickly view the listed document object without jumping, a local page index listing the document objects with support of frames is shown in FIG. 25. Local indexes 254 which are in a side frame are typical image indexes in thumbnails for image objects. When clicking on thumbnail 250, the original size image 252 will be directly displayed in a main frame. The Visual Navigation Tabs of the Dynamic Book is still displayed in a frame on top. In such a way an efficient navigation approach is provided. FIG. 25A gives a typical example where the local indexes 259 are in a filename format. When clicking on filename 258, the original document object 256 will be displayed directly if it is compatible with web or displayed with support of plug-ins. The document object taken as an example in FIG. 25A is in PDF format and Acrobat PDF reader plug-in is invoked for displaying the document object. Local indexes combining thumbnails (for images) and titles (for other document objects) are also invented for efficient quick viewing.

Managing Document Objects

In preferred embodiments, to perform document object management, selection or group selection for the document objects can be done at navigation time. With the support of the program modules, the selected document objects can be copied, cut, moved between the Dynamic Pages, Sections and Dynamic Books. After copying or cutting, navigate to the destination Dynamic Page, paste the document object(s) from the Dynamic Book system clipboard or local computer system clipboard. In addition, the selected document object(s) can be directly deleted in response to a request from a user interface. After the management operations, the Dynamic Book or Dynamic Pages are immediately revised and updated.

The hosted document objects listed can be sorted by name, by title, by modified date or by type etc. in response to a request from a user interface.

Communication of Document Objects

In preferred embodiments, with the support of built-in or embedded program modules, plug-ins or third party applications, the selected document objects hosted in Dynamic Books can be sent to other locations of the network via email, FTP (or HTTP, or other communication protocols), fax or other network data transmit approaches in response to a request from a user interface.

The currently displayed Dynamic Page (or Section or sub-Section or Dynamic Book), in a package, can be sent out via email, FTP (or HTTP, or other communication protocols), fax or other network data transmitting approaches with the support of program modules or third party applications, in response to a request from a user interface.

Working Desk

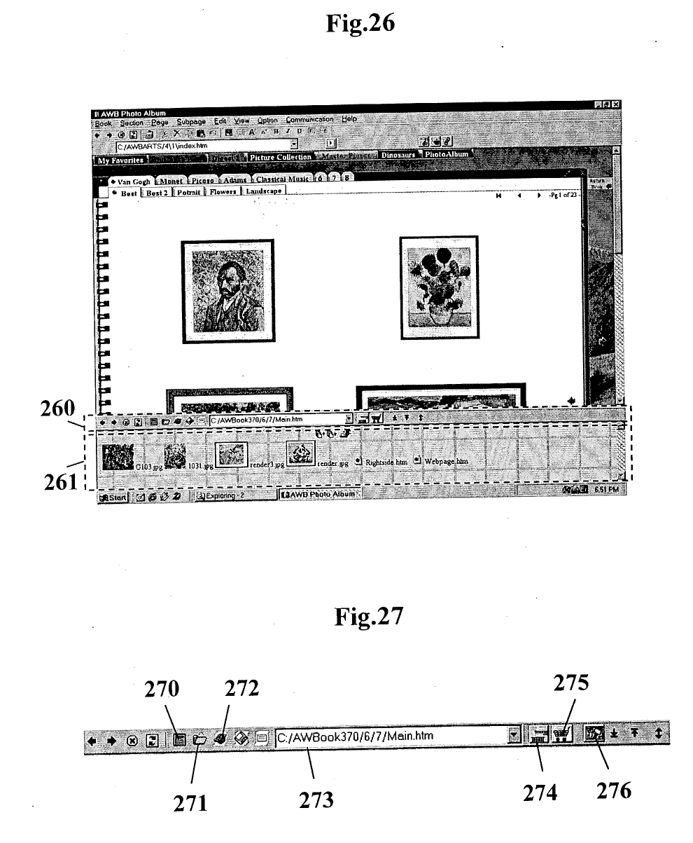

In preferred embodiments, to perform document operation more efficiently, there is a working desk at the lower portion of the software program user interface which comprises of a lower window 261 and toolbar icons 260 as shown in FIG. 26.

The lower window 261 displaying a Dynamic Book in web browser or web viewer is used for drag-and-drop to copy or move the selected document objects across two Dynamic Books.

The lower window 261 displaying a clipboard is used to copy and move selected document objects in patch. The lower window 261 displaying an on-line web page in web browser or web viewer is used to copy, save selected web objects or a selected web page to the Dynamic Book from the Internet or Intranet etc. The lower window 261 displaying local or network directory is used to copy or move the selected document objects to the Dynamic Book from the directory. The lower window 261 displaying inbox and outbox is used for receiving documents to the current Dynamic Page or sending out documents from the current Dynamic Page in patch. The lower window 261 displaying icons linking to built-in modules or third party applications is used for executing programs for instant editing, processing or communicating a document object by drag-and-drop.

As shown in FIG. 27, icon 270 is used to display a Dynamic Book and icon 271 is to display a local system directory. Icon 272 is to display a online web page and icon 273 is used to key-in a web address for displaying a web page in the lower window. Icon 274 is used to display a duplication tray (clipboard) and Icon 275 is used to display the moving tray for moving document objects to other locations in patch. Icon 276 is used to display the application program icons in the lower window linking to the embedded program modules and third party applications.

Multiple Volumes for One Book

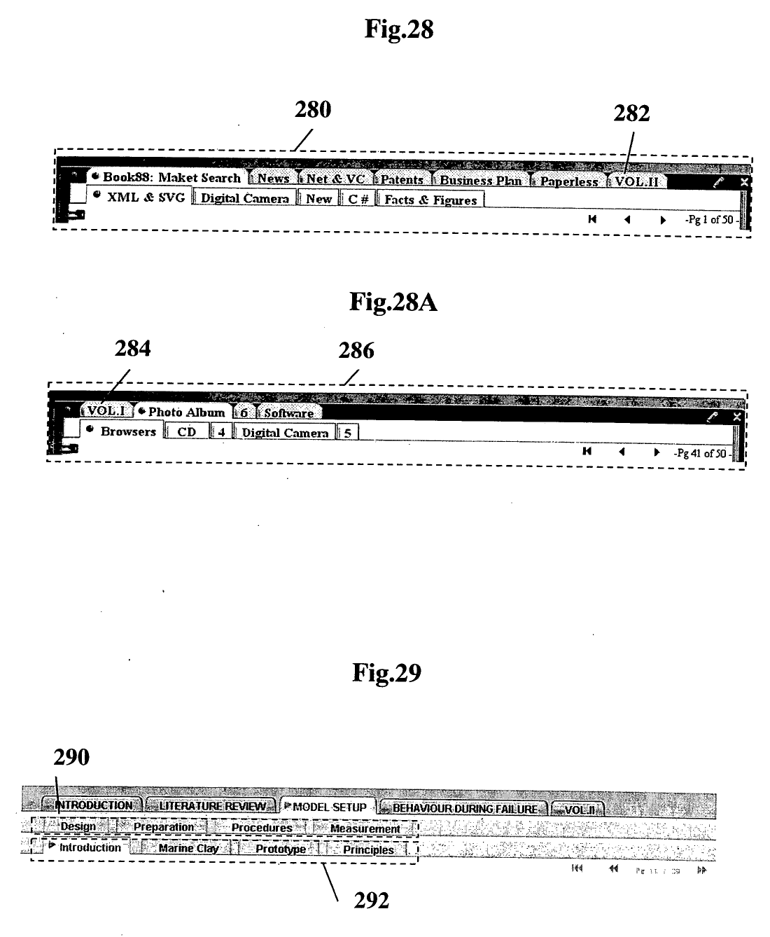

When Visual Navigation Tabs excesses the screen displaying space, the Visual Navigation Tabs can be automatically separated as two volumes as shown as in FIG. 28, where 280 is volume I and 286 is volume II, and the two volumes are linked with volume Tabs 282 and 284.

Multi Layers at One Level

When Visual Navigation Tabs excesses the screen displaying space, the Visual Navigation Tabs can be automatically separated as the two rows 290 and 292 as shown in FIG. 29.

Table of Contents

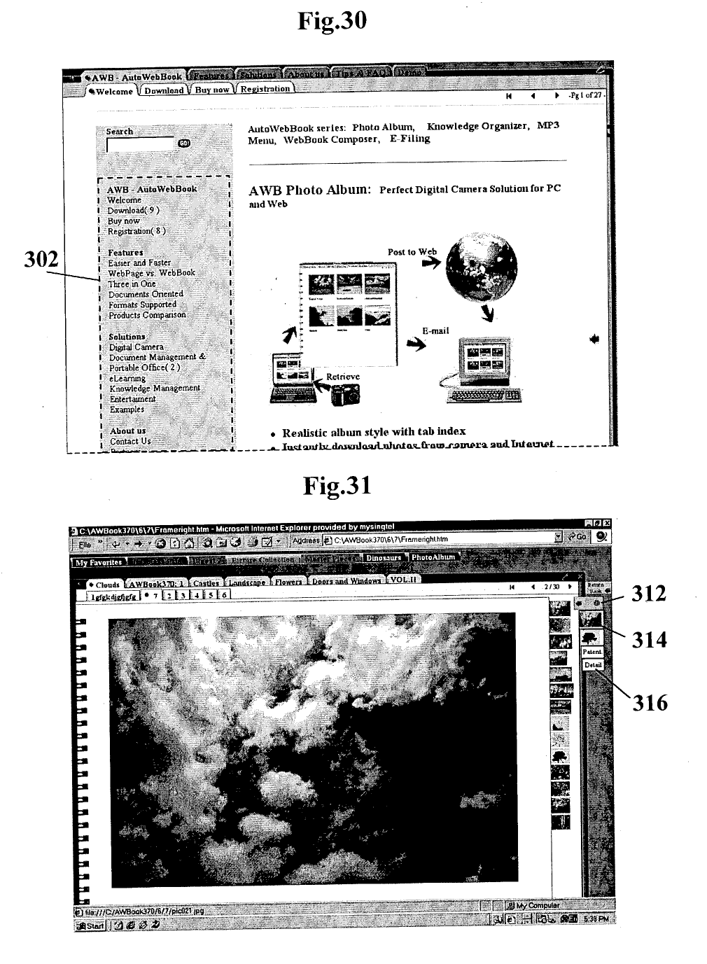

Based on the existing structure of the Dynamic Book, a table of contents 302 can be generated automatically on the front page (or home page) as shown in FIG. 30. The titles are listed and hyperlinks are created for each Section, Sub Section and Dynamic Page in the table of contents.

Visual Bookmarks and Shortcuts

As shown in FIG. 31 in a Dynamic Book, bookmark 312 can be visually attached to a Dynamic Page as a shortcut linking to the marked page for convenient relocation. The bookmark can be shifted from the original location to the current location in response to a request from a user interface. For an image document object, shortcut 314 in the form of a thumbnail directly links to the original image object. For general format document objects, text labels 316 links to the original document objects. The bookmarks and shortcuts are displayed at the side of book and they are always visible at any location.

Navigation Time Operations Icons

In preferred embodiments, to perform navigation time operations, Navigation Time Operations Icons are displayed on the web page surface for user to click and invoke embedded program functions. Such web browser or web viewer based user interface implements web displaying and application functions call to take the place of window application user interface with menu and toolbars.

The said Navigation Time Operations Icons are web image objects being displayed on the web page and linking to target objects with specified function calls of program. When an icon object is clicked, a function call will be invoked. With such Navigation Time Operations Icons, a web browser based, a platform independent user interface for document operation can be created.

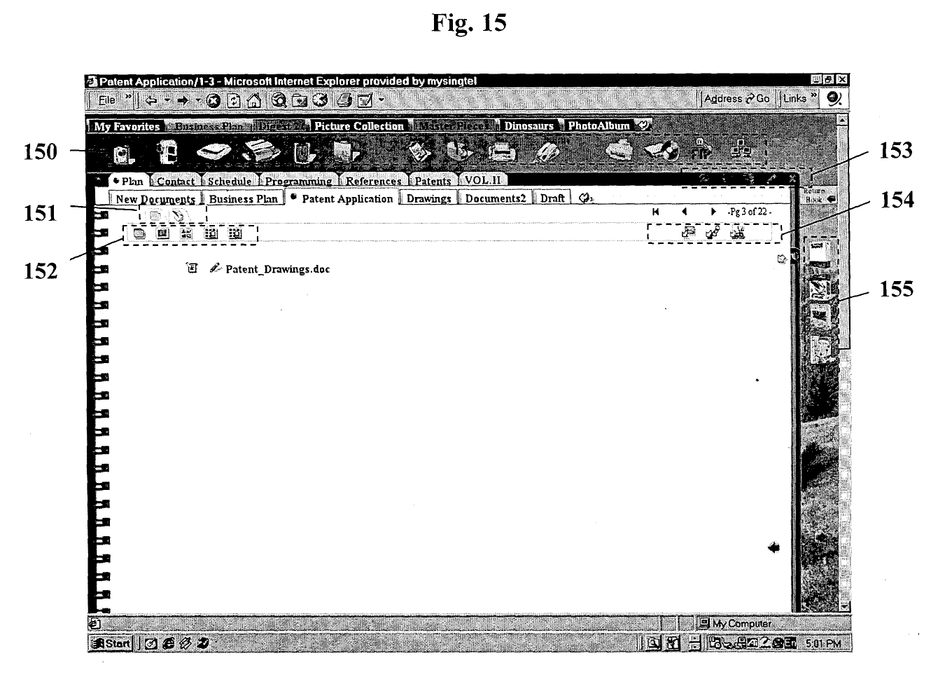

FIG. 15 is an overview of Navigation Time Operations Icons for instant document communications, customization etc. Icons 150 are used for instant document communications. Icons 151 are used to switch between the document management mode and web page editing mode. Icons 152 are used to customize the size and layout for the displayed document objects. Icons 153 are used to customize the styles of Dynamic Books and Icons 154 and 155 are used to instantly create document objects to current page and run up the corresponding applications for instant editing or processing.

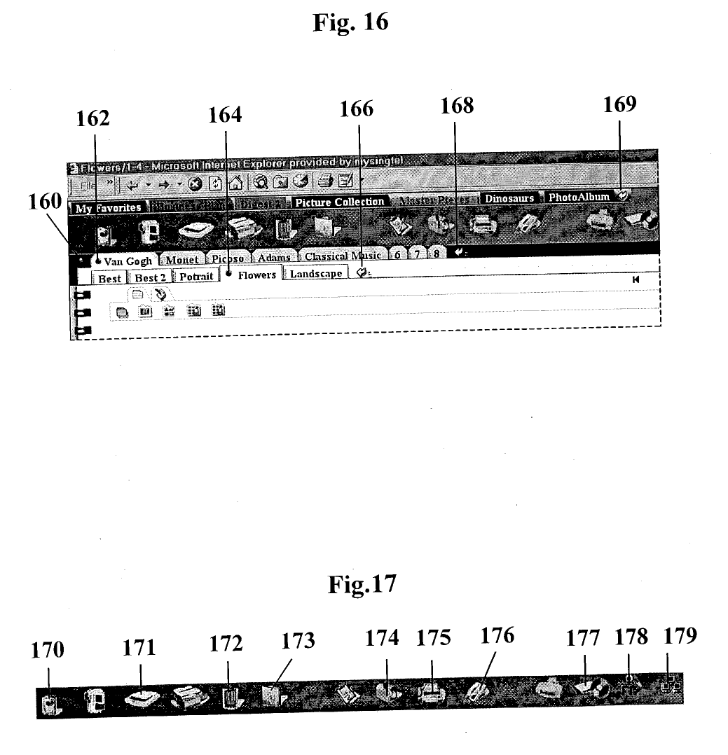

As shown in FIG. 16, instant generation of a new Dynamic Book can be performed by clicking icon 169. Instant generation of a new Section can be done by clicking icon 168 and instant generation of a new Dynamic Page can be done by clicking icon 166. Such instant generations are all carried out in response to a request from web browser or web viewer user interface at navigation time.

To instantly customize the Dynamic Book like changing the titles, orders and styles of the Dynamic Navigation Tabs, book property icon 160, Section property icon 162 and Page property icon 164 are displayed for user to make the changes from web browser or web viewer user interface at navigation time.

Instant Adding of Document Objects to Current Page

While navigating the Dynamic Books, instantly adding any type of document objects into the currently displayed page surface can be done by clicking the icons shown in FIG. 17. Icon 170 is used for instantly loading images from a digital camera. Icon 171 is for invoking a scanner and loading scanned image to the current page. Icon 172 is for loading document objects from PDA (Personal Digital Assistant) and icon 173 is for an instant input of document objects from the local computer or computer networks. The loaded document objects are automatically displayed on the current page in filename or title of documents, or directly displayed document contents. The instant input form of computer peripheral devices, information devices, mobile phone and their combinations, as well as other electronic devices, digital processing system and network resource etc. all can be fulfilled by means of Navigation Time Operations Icons.

Instant Management of Document Objects

While navigating the Dynamic Book, the displayed document objects and the current Section or Page can be instantly copied, cut and deleted by means of such Navigation Time Operations Icons.

Instant Execution of Document Objects

When the current document objects are displayed, a series of function icons linking to the corresponding or compatible application programs are listed for optional execution like opening and editing, reading the metafile of the object, going to the original file source (URL) and so forth.

Instant Communications

With the support of built-in modules and/or third party applications, the selected document objects hosted in the Dynamic Book can be instantly sent to other location via email, FTP (or HTTP, or other Internet application protocols), peer to peer network approach in response to a request from a user interface by clicking the communication icon objects. Icon 174 is used for an instant attachment of selected document objects to an email program. Icon 175 is for instant faxing for selected document objects to a fax program. Icon 176 is for instant online IP phone call, chat or conference, business talk etc from a selected object with the contact number, address or hyperlinks. Icon 177 is for writing selected document objects or current Dynamic Book or Section or Page into a recordable CD for backup or distribution. Icon 178 is for instant transferring via FTP for selected document objects or current Dynamic Book or Section or Page. Icon 179 is for instant network sharing for selected document objects or for the current Dynamic Book, the current Section and current Page. The communications are produced with built-in modules or third party applications or plug-ins.

Instant Generation of a Dynamic Bookshelf or a Dynamic Library

Instant generation of a new Dynamic Bookshelf is carried out by clicking icon 216, and instantly generation of a Dynamic Library is carried out by clicking icon 217 in FIG. 21 with support of built-in modules in the system.

Varieties of Dynamic Book in the Form of Dynamic Navigation Bars

In the preferred embodiments described above, Visual Navigation Tabs are preferred. The look-and-feel of a physical book or a physical file is presented in the styles as displayed in FIG. 1 and FIG. 31, but the invention is not limited to the styles in the given figures. In spite of the varieties in styles and appearances, if the methods for dynamically generating structured web pages in the same mechanism as indicated in FIG. 13 and FIG. 14, presenting part or full hierarchical structures of web pages and dynamical assembling text title and highlighting the current location of Dynamic Page (including Section and Sub Section) are still used, the structured web pages with the above features are still defined as Dynamic Books. The corresponding navigation bars used for the Dynamic Book described here are more varied in styles and appearances and are named as Dynamic Navigation Bars. Dynamic Navigation Bars are also part of the described invention, which are further described as the following:

Referring to the early part of the description, Dynamic Navigation Bars provide more general varied styles. The look-and-feel of tabs (or divider or index labels) of physical books or files and the visual effects showing the current tab is brought to the front are not the basic features. More varieties of Dynamic Books are presented in Dynamic Navigation Bars.

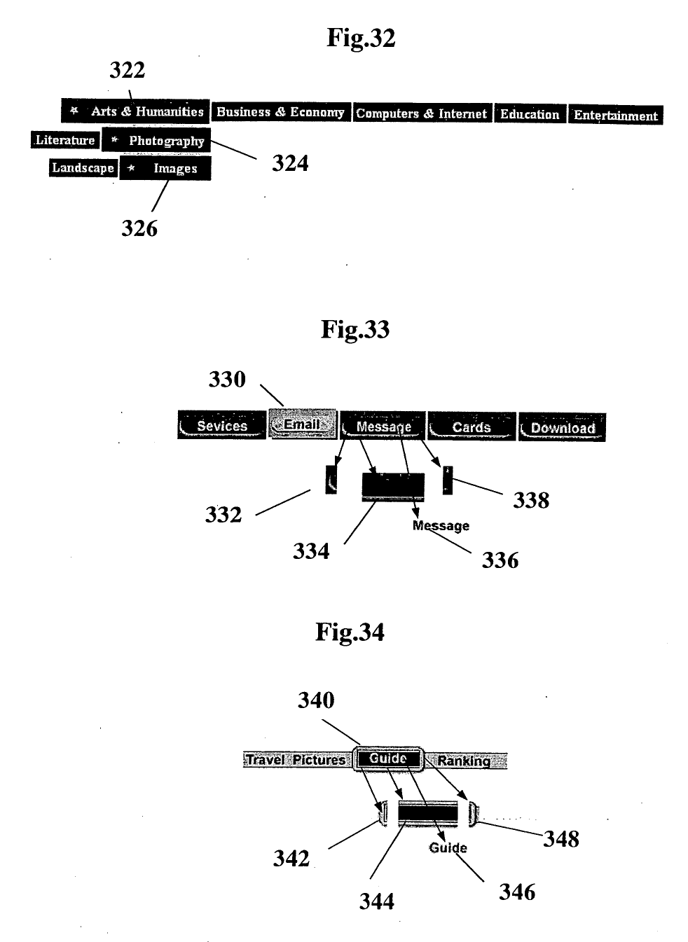

FIG. 32, as an embodiment, indicates how Dynamic Navigation Bars consistently display the hierarchical structure and logical relation between the current page and the rest of the pages of the book. Current Section 322, current Sub Section 324 and current Page 326 are highlighted and the logical relations are indicated. Hyperlinks to the rest of the book are also provided to let the users jump to the rest of the pages of the book.

FIG. 33, as an embodiment, indicates how Dynamic Navigation Bar 330 highlights the location of current Section or current Page. Although the highlighting effect is common in graphic navigation bar, but the dynamical assembling in markup language with title in text format and graphics (and/or images) is used. For example, 332 is a left border image of a navigation button, 334 is a middle background image and 336 is a text title which can be dynamically changed in response from a user interface and 338 is a right border image. Alternatively, the left border image 332 and the right border image 338 can be omitted and an image or an icon can be added to the bar.

FIG. 34, as another alternative style, indicates how Dynamic Navigation Bar 340 highlights the location of the current Section or Page in another style. In FIG. 34, 342 is a left border image of the current navigation button, 344 is the middle background image and 346 is the text title which can be dynamically changed in response from a user interface and 348 is a right border image.

Visual Hierarchical Cards

To fully or partly present the hierarchical structures of the directory tree of the computer operating system and the hosted document objects or web pages, Visual Hierarchical Cards are invented based on the same mechanism as indicated in FIG. 13 and FIG. 14 for Dynamic Book. In web standard presentation, document (file) management and operation in a user-friendly environment can be conducted. Visual Hierarchical Cards are featured in database 69 or 69A supporting the hierarchical structure of a Dynamic Book is the same as the hierarchical directory structure of the computer operating system. The number of cards and the hierarchical levels of the cards are unlimited and extensible and can be customized in response to the requests from a user interface at navigation time. The cards and hosted document objects in Visual Hierarchical Cards corresponds to the computer hierarchical tree including directories (folders) and document objects (files) in the directory. When a card or a document object is added into Visual Hierarchical Cards, a corresponding directory or document object is added synchronously in the hierarchical tree of the computer operating system. If there are existing hierarchical trees with multiple-level directories and document objects hosted in them, the Visual Hierarchical Cards can read through the directory trees and present them in web pages in the same mechanism of Dynamic Books with the support of software programs.

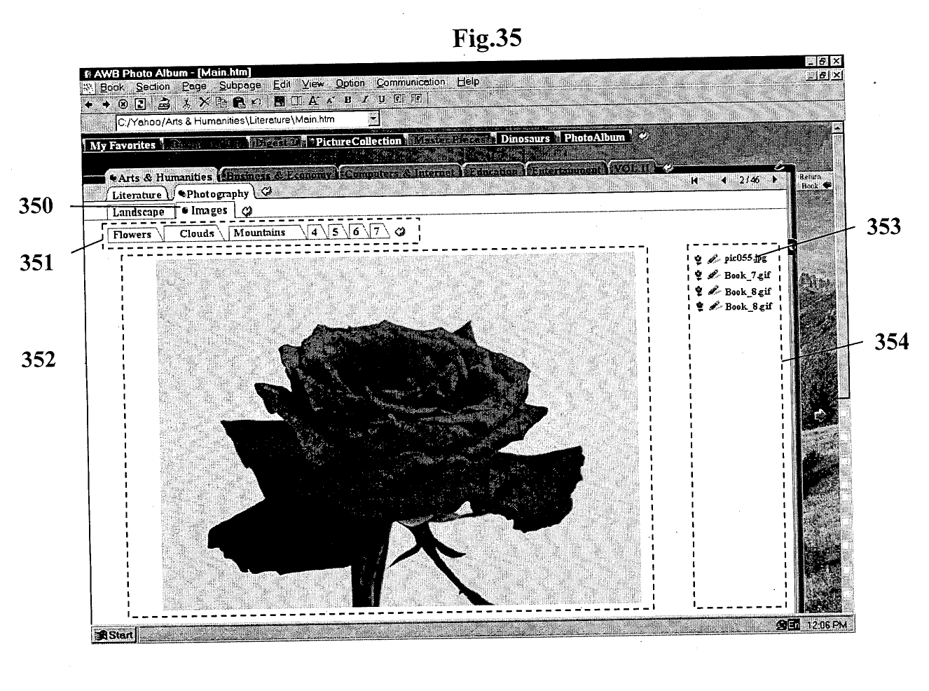

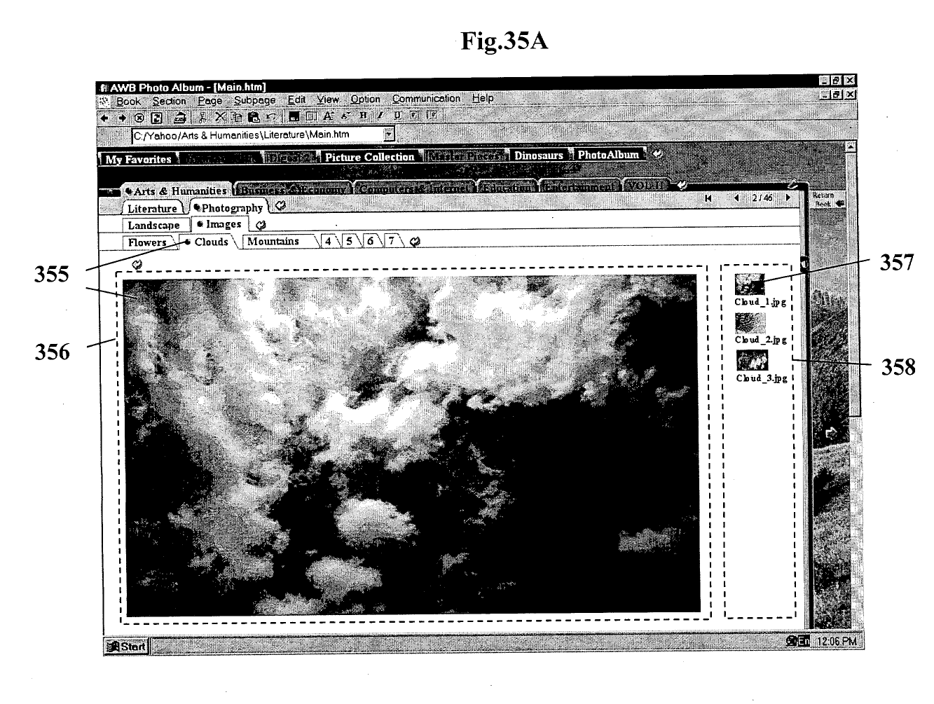

Preferably, as shown in FIG. 35, a typical currently displayed card 350 is located in the Visual Hierarchical Cards as illustrated. Under this card, there are document objects 354. One of the document objects 353 in image format is directly displayed as 352 with the support of frames for web pages. On this card, sub-cards under this card are listed as 351. When clicking the sub-cards 355, the sub card will be opened as shown as FIG. 35A. On the newly opened sub-card, the document objects under this sub card are listed as 358, and one of the listed document objects 357 is currently displayed as 356. Alternatively, by clicking a displayed document object, create a web page which includes the document contents and a hyperlink linking to the current card of Visual Hierarchical Cards and/or a hyperlink linking to the next document displayed on the current card of Visual Hierarchical Cards. Alternatively, create a webpage which include two parts, first part displays a navigation list named Local Index which lists the document objects hosted in the current card and second part directly displays the content for the clicked or pointed document in said Local Index.

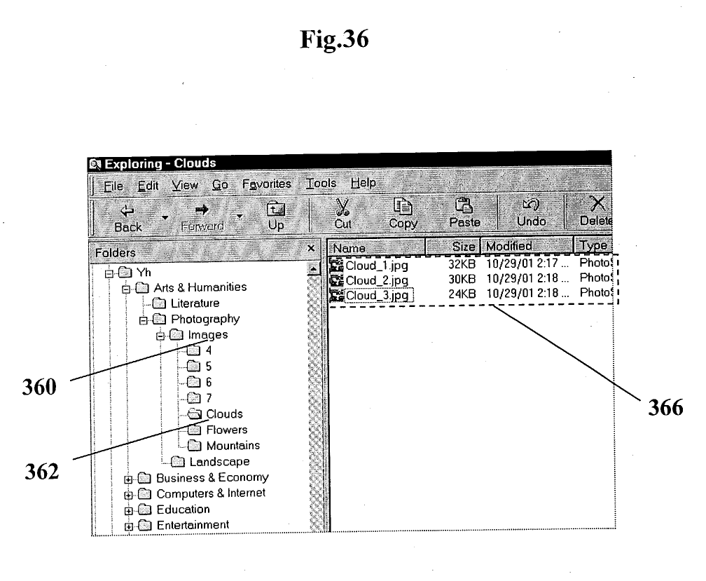

Comparing to computer the hierarchical directory tree in Windows Explorer in FIG. 36, card 350 corresponds to folder 360, card 355 corresponds to folder 362 and document objects 358 corresponds to files 366.

In such a way described above, Visual Hierarchical Cards are integrated with the hierarchical directory tree of a computer system. However, the Navigation Time Operations Icons used in Dynamic Books described in the early part of the description are still applicable in the environment of Visual Hierarchical Cards. Adding a new Card is performed in the same way as adding a new Dynamic Page or Section for Dynamic Books. Renaming a card and reordering the cards are produced in the same ways as customizing the titles of Pages and Sections for Dynamic Books. In the top level of Visual Hierarchical Cards, Visual Hierarchical Cards could be in the same style as Dynamic Books and could be linked to the environment of Dynamic Bookshelves and Dynamic Libraries. Adding document objects and displaying document objects are in the same way as those in the Dynamic Book. Quick-viewing with support of frames, managing document objects such as copying, cutting and deleting, operating document objects such as email, fax, FTP and sharing are also in the same way as those in the Dynamic Books. The others such as Working Desk, dragging and dropping, Visual Page Marks, Shortcuts and Navigation Time Operations Icons used for Dynamic Books described before are all applicable and can be used in the Visual Hierarchical Cards environment.

What I claim as my invention is:

1. A method of making web pages in markup language on local computer, computer over the network, server, digital device or digital processing system, the method comprising:
dynamically generating a set of pages named as Dynamic Pages which are created in batch with support of software program and/or created gradually with support of software program and operations on user interfaces;
said Dynamic Pages are grouped and linked with a standardized navigation bar or a set of standardized navigation bars, said standardized navigation bar(s) is named as Visual Navigation Tab(s), said Dynamic Pages, as one set, are named as Dynamic Book;
said Visual Navigation Tabs are dynamically assembled with graphics (and/or images) and titles which match together by the syntax of markup language, to present look-and-feel of tabs or attached labels of physical book or physical file and visual effect that the tab or attached label of current displayed page or Section or sub-Section is brought to the front to indicate the current status, and such visual effect is automatically shifted to another Dynamic Page or Section or sub-Section when navigating to another Dynamic Page or Section or sub-Section;
said Visual Navigation Tabs, in one level or multiple hierarchical levels, partially or entirely, present the hierarchical structure of pages of Dynamic Book, the tabs or attached labels at top hierarchical level, if exist, represent Sections or Dividers of Dynamic Book, the tabs or attached labels at lower hierarchical levels, if exist, represent sub-Sections or Sub Dividers of Dynamic Book, the tabs or labels visually connected or attached to Dynamic Pages represent Dynamic Pages;
said titles on Visual Navigation Tabs are in text format which can be dynamically written and changed with support of software program.

2. The method according to claim 1, wherein a single tab of Visual Navigation Tabs include at least left border image, middle background image, title in text format and right border image, which match together to form a realistic tab, the width of a tab of Visual Navigation Tabs can be automatically adjusted according to the length of title, with support of software program.

3. The method according to claim 1, wherein said Visual Navigation Tabs is dynamically written based on a database, a data file or a XML file, or their combination, with support of software program, said database, a data file or a XML file can be an existing one or created in respond of a request from user interface locally or over network.

4. The method according to claim 1, wherein said Visual Navigation Tabs are dynamically generated based on the structure of an existing hierarchical directory tree in a computer's file system or local/network storage system, with support of software program.

5. The method according to claim 1, wherein said Visual Navigation Tabs present visual effects that the current displayed or specially selected page, Section or sub-Section is highlighted in different colors, shapes, marks, lighting effects, animation effects, additional icons or additional images.

6. The method of claim 1 further including:
adding a new Dynamic Page, a new Section or a new sub-Section to the current Dynamic Book at Navigation Time in response to a request from user interface;
automatically generating Visual Navigation Tabs represent the newly added Dynamic Page or Section or sub-Section respectively, and automatically re-writing and updating Visual Navigation Tabs on the rest of related web pages with support of software program.

7. The method of claim 1 further including:
adding a navigation bar which represents and links to another Dynamic Book on the web pages of currently displayed Dynamic Book, the navigation bar named as Book Cover provides look-and-feel of a physical book or a physical file partially or entirely and displays the title of represented Dynamic Book;
arranging added Book Covers in one or more rows which is named as a Bookshelf.

8. The method of claim 1 further including:
adding document objects to the currently displayed Dynamic Page of Dynamic Book from digital camera, scanner, digital copier, PDA (Personal Digital Assistant), mobile phone, multifunction devices, local computer, network computer or Internet with support of software program;
displaying the added document objects on the Dynamic Page in filenames or/and titles or/and thumbnails or/and attributes or/and meta-data or/and keywords or/and abstract or/and summary or/and full contents or part of contents;
linking the displayed filenames or/and titles or/and thumbnails to the document objects.

9. The method of claim 1 further including:
adding document objects to the Dynamic Page;
creating at least three frames on a Dynamic Page, first frame displays Visual Navigation Tabs, second frame displays a navigation list named Local Index which lists the document objects added to the current Dynamic Page, and third frame directly displays contents of a selected document by clicking or pointing a document listed by Local Index in second frame, said Local Index lists document objects in filename, part of filename, in thumbnail or in serial number.

10. The method of claim 1 further including:
adding and displaying document objects on the Dynamic Page; displaying the added document objects on the Dynamic Page in filenames or/and titles or/and thumbnails and displaying icons beside each documents;
clicking the icons to activate a corresponding applications or a source application for instantly editing or processing documents, in response to a request from user interface at Navigation Time.

11. The method of claim 1 further including:
adding and displaying document objects on the Dynamic Page;
selecting a document object or a group of document objects displayed on the current Dynamic Page in response to a request from user interface at Navigation Time;
sending the selected document objects to other location of network via email, FTP, fax or via other network data transmit approaches with support of program modules or third party applications in response to a request from user interface.

12. The method of claim 1 further including:
adding and displaying document objects on the Dynamic Page;
selecting a document object or a group of document objects displayed on the current Dynamic Page in response to a request from user interface at Navigation Time;
copying or cutting the selected document objects to clipboard of Dynamic Book system or clipboard of computer operating system or deleting the selected document objects.

13. The method of claim 1 further including:
adding and displaying document objects on the Dynamic Page;
selecting a document object or a group of document objects displayed on the current Dynamic Page in response to a request from user interface at Navigation Time;
dragging and dropping selected document objects to a specified target object to copy, move document or to activate a third party application for instant document editing, processing or communication.

14. The method of claim 1 further including:
dividing said Visual Navigation Tabs in the same hierarchical level into two or more parts with visual effect that the Dynamic Book is separated into two or more volumes; or dividing said Visual Navigation Tabs in the same hierarchical level into two or more rows.

15. The method of claim 1 further including:
dynamically generating a table of contents on one of Dynamic Pages, in said table of contents the titles of Sections and sub-Section and Dynamic Pages are listed and hyperlinks are created for each Section and sub-Section and Dynamic Pages.

16. The method of claim 1 further including:
generating a bookmark for a selected Dynamic Page or a selected document object which presents at any Dynamic Pages of a Dynamic Book and directly links to the selected Dynamic Page or the selected document object.

17. The method of claim 1 further including:
adding and displaying document objects on the Dynamic Page;
generating icon objects (images or graphic objects) beside displayed document objects respectively, icon objects are clickable and linked to specified objects for invoking specified program functions for document management, processing and/or communications, said icon objects are named Navigation Time Operation Icons.

18. The method according to claim 1, wherein said Visual Navigation Tabs are arranged vertically and located on left side or right side of a Dynamic Book.

19. A method of making web pages on a local computer, a computer over network, a digital device or a digital processing system, the method comprising:
dynamically generating a web page or a set of web pages named as a Dynamic Library with support of software program;
said Dynamic Library includes a Dynamic Bookshelf or a set of Dynamic Bookshelves, a Dynamic Bookshelf includes a Book Cover or Book Covers, said Book Covers represent and link to Dynamic Books;
said Book Covers are dynamically assembled with elements of graphics or images or texts or combination of graphics, images and texts, the elements match together by the syntax of markup language, to present look-and-feel of physical book cover or physical file cover.

20. The method according to claim 19, wherein said elements for dynamically assembling a full or a partial Book Cover include at least left border image, middle background image, title in text format and right border image, which match together in markup language and said Book Cover include titles in text format that can be dynamically written and changed, and the width of tabs can be automatically adjusted to match the length of titles;
said left border image and right border image for Book Cover include of book cover face and edges and bookshelf background to match to present a look-and-feel of a real bookshelf.

21. The method according to claim 19, wherein said elements for dynamically assembling full or partial Book Cover include at least upper left border image, upper middle background image, title in text format and upper right border image, lower left border image, lower middle background image, cover image and lower right border image, which match together in markup language, said upper left border image, upper right border image, lower left border image, lower right border image for Book Cover include book cover face and edges and bookshelf and bookshelf background to match to present a look-and-feel of a real bookshelf.

22. The method of claim 19 further including:
dynamically adding a new Dynamic Book to Dynamic Bookshelf, and/or dynamically adding a new Dynamic Bookshelf to Dynamic Library and/or dynamically adding a new Dynamic Library and link the new added Dynamic Library to the old Dynamic Library in response to a request from user interface.

23. A method of making web pages on local computer, computer over network, server, digital device or digital processing system, the method comprising:
dynamically generating a set of pages named as Dynamic Pages which are created in batch with support of software program and/or created gradually with support of software program and operations on user interfaces;
said Dynamic Pages are grouped and linked with a standardized navigation bar or a set of standardized navigation bars, said standardized navigation bar(s) is named as Dynamic Navigation Bar(s);
said Dynamic Navigation Bars are dynamically assembled with graphics (or images) and titles which match together by the syntax of markup language, to present the effect that the current displayed page or Section or Sub Section is highlighted and such a highlighting effect is automatically shifted to another Dynamic Page, Section or sub-Section when navigating to another Dynamic Page, Section or sub-Section;
said Dynamic Navigation Bars, in one level or multiple hierarchical levels, partially or entirely, present the hierarchical structure of pages of Dynamic Book, the bars at top hierarchical level, if exist, represent Sections or Dividers of Dynamic Book, the bars at lower hierarchical levels, if exist, represent sub-Sections or sub-Dividers of Dynamic Book, the bars at lower hierarchical levels represent Dynamic Pages.

24. A method of presenting hierarchical directory/folder system in web page format on a local computer, a computer over network, a server, a digital device or a digital processing system, the method comprising:
reading through and getting the structural data of selected path and level of the existing hierarchical directory/folder with support of software program;
dynamically generating a web page or a set of web pages which include a set of standardized navigation bars named as Visual Hierarchical Cards based on said structural data, the hierarchical structure and titles of said Visual Hierarchical Cards is corresponding to the selected part or entire existing hierarchical directory/folder;
reading through a selected hierarchical level and displaying filenames, and/or titles, thumbnails, contents or part of contents of document objects at the selected hierarchical level;
linking the displayed filenames, and/or titles, thumbnails, contents or part of contents of document objects to the document contents;
reading through a selected hierarchical level and displaying sub-directories or sub-folders at the selected hierarchical level;
said Visual Hierarchical Cards present visual effect that current cards along the current path at higher hierarchical levels and current level are highlighted and the highlighting effects are automatically shifted to another card and/or another path when navigating to another card and/or another path.

25. The method according to claim 24, further including:
adding a new card to the existing Visual Hierarchical Cards and the corresponding directory/folder is generated at the same time with support of software program.

26. The method according to claim 24, wherein said Visual Hierarchical Cards are dynamically assembled with graphics (and/or images) and titles which match together by the syntax of markup language, to present look-and-feel of tabs or attached labels of physical book or physical file and visual effect that the tab or attached label of current displayed cards are brought to the front to indicate the current status, the said titles are written based on said structural data of selected path and level of the existing hierarchical directory/folder of a computer storage system and/or a network storage system;
a single tab or label of said Visual Hierarchical Cards include at least left border image, middle background image, title in text format and right border image, which match together to form a realistic tab, the width of tab can be automatically adjusted according to the length of title, with support of software program.

27. The method according to claim 24, wherein top level of Visual Hierarchical Cards are in form of visualized bookshelves and the second level of said Visual Hierarchical Cards are in form of visualized physical books or physical files.

28. The method of claim 24 further including:
adding new document objects to current card of Visual Hierarchical Cards from digital camera, scanner, digital copier, PDA (Personal Digital Assistant), local computer directories/folders, computer network or Internet.

29. The method of claim 24 further including:
selecting and sending selected document object(s) displayed on current card of Visual Hierarchical Cards via email, fax, FTP, HTTP, or other Internet application protocols with support of software program or third party applications.

30. The method of claim 24 further including:
copying, cutting, deleting displayed document object(s) from current card (page) of Visual Hierarchical Cards.

31. The method of claim 24 further including:
clicking a displayed document object and creating a web page which includes the document contents and a hyperlink linking to the current card of Visual Hierarchical Cards and/or a hyperlink linking to the next document displayed on the current card of Visual Hierarchical Cards.

32. The method of claim 24 further including:
creating a webpage which include two parts, first part displays a navigation list named Local Index which lists the document objects hosted in the current card and second part directly displays the content for the clicked or pointed document in said Local Index.
